(19) United States
(12) Patent Application Publication
(10) Pub. No.: US 2010/0228651 A1
(43) Pub. Date: Sep. 9, 2010

(54) Systems and Methods for Providing Loans in Response to the Occurrence of Predetermined Events

(75) Inventors: Manuel Becerra, Miami, FL (US); M. Elaine Robinson, Miami, FL (US); Tricia Meyer, Atlanta, GA (US); Madelene Souffront-Garcia, Miami, FL (US); Chris Bartosik, Buffalo Grove, IL (US); Cassandra Conrad, Naples, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Assurant, Inc.

(21) Appl. No.: 12/716,830

(22) Filed: Mar. 3, 2010

Related U.S. Application Data
(63) Continuation-in-part of application No. 12/539,297, filed on Aug. 11, 2009.
(60) Provisional application No. 61/157,466, filed on Mar. 4, 2009.

(51) Int. Cl. G06Q 40/00; G06Q 20/00; G06Q 30/00; G06Q 10/00

(52) U.S. Cl. 705/34; 705/38; 705/30

(57) ABSTRACT

Systems, methods, and computer program products are provided that allow customers to build equity (e.g., by adding money to their selected savings vehicle) feeling secure in knowing that, should they undergo one of the pre-determined events, they will have access to a low/no interest loan (or other loan) that will help them get through that period of crisis. The financial product may offer customers a collateralized loan during a time of need, the ability to set and redefine savings goals to reflect changes in a customer's life, savings on fees as collateral grows, the waiver of monthly fees during benefit period and for a one-month grace period, and a manageable payback schedule once the benefit period begins.

### CROSS-REFERENCE TO RELATED APPLICATIONS

This application claims priority to U.S. Provisional Application No. 61/157,466, filed Mar. 4, 2009, and further claims priority to U.S. patent application Ser. No. 12/539,297, filed Aug. 11, 2009, which claims priority to U.S. Provisional Application No. 61/088,172, filed Aug. 12, 2008, each of which is hereby incorporated herein in its entirety by reference.

### BACKGROUND OF VARIOUS EMBODIMENTS

Although many consumers are aware of the conventional wisdom of saving three to six months salary for emergencies, few actually have that amount of savings in some form of liquid assets. As a result, an unexpected loss of income could have devastating results for many consumers. Without sufficient savings, even a short-term loss of income could significantly affect a consumer's life. In addition, many people tend to underestimate the amount of money they should have available during a time of need.

Furthermore, people have different attitudes about how/when to use their savings. Some consumers are willing to dip into their hard-earned savings when a time of need comes around due to circumstances such as involuntary unemployment, disability, or hospitalization. Others would rather find alternative sources to meet financial needs during these times. In fact, according to recent research, for those who do have some form of savings available to them, there is a high reluctance to tap into those savings during times of need. This reluctance may be because consumers feel that these funds are their personal safety net and that depleting this source could leave them in dire circumstances. Or, in the case of consumers that have their savings in the form of investment or high yield savings vehicles, the concern may be that if they use these funds, they could be subject to substantial penalties for withdrawal or lose interest/investment gains.

Accordingly, Applicant has discovered that it would be desirable to provide systems and methods for allowing customers access to alternative sources of funds during times of need, such as when the customer is disabled or unemployed and ineligible for loans or credit increases. As described in greater detail below, a variety of challenges were identified and overcome through Applicant's efforts to invent and develop such systems and methods.

### BRIEF SUMMARY OF VARIOUS EMBODIMENTS

Systems, methods, and computer program products according to various embodiments of the invention provide a financial product that guarantees customers access to a low or no interest loan that is collateralized against a pre-determined savings vehicle upon the occurrence of a pre-determined event, such as the involuntary unemployment, disability or hospitalization of the customer (or other predetermined event).

In one embodiment, a method of providing funds to a customer upon the occurrence of one or more pre-determined events is provided. The method comprises the steps of generating a user interface configured to receive loan application input from a customer including a designation of an associated savings vehicle, calculating a periodic payment to be received from the customer upon approval of the loan application, and providing a guaranteed loan to said customer upon the occurrence of the one or more pre-determined events. The periodic payment may be calculated based at least in part on a savings vehicle account balance.

In some cases, the loan application input includes a selection of at least one parameter by the customer. The periodic payment may be determined based at least in part on the selection of the at least one parameter, and the at least one parameter may be selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit. The user interface may be configured to receive input from the customer changing the selection of the at least one parameter. Furthermore, the periodic payment may be adjusted based on the input received changing the selection of the at least one parameter.

An estimated range of periodic payments may be calculated, and an indication of the estimated range of periodic payments may be provided to the customer through the user interface. In addition, the customer may be provided with access to real-time account information through the user interface.

The periodic payments made by the customer may be received, and a savings vehicle account balance may be tracked in some cases. The periodic payments may be adjusted when the savings vehicle account balance exceeds a predetermined threshold amount. Furthermore, funds may be withdrawn from the savings vehicle upon the customer's default on repayment of the guaranteed loan.

In other embodiments, a computer readable storage medium may be provided comprising computer-executable instructions for performing various functions, including generating a user interface configured to receive loan application input from a customer including a designation of an associated savings vehicle; receiving information regarding a savings vehicle account balance; and calculating a periodic payment to be received from the customer based at least in part on the savings vehicle account balance. A guaranteed loan may be provided to said customer upon the occurrence of the one or more pre-determined events, and the guaranteed loan may be secured by the savings vehicle.

In some cases, the loan application input may include a selection of at least one parameter by the customer. The periodic payment may be calculated based at least in part on the selection of the at least one parameter, and the at least one parameter may be selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit. The user interface may be configured to receive input from the customer changing the selection of the at least one parameter. Furthermore, the periodic payment may be adjusted based on the input received changing the selection of the at least one parameter.

The computer readable storage medium may further comprise computer-executable instructions for calculating an estimated range of periodic payments and providing an indication of the estimated range of periodic payments to the customer through the user interface. The customer may also be provided with access to real-time account information through the user interface, and the periodic payments may be adjusted when the savings vehicle account balance exceeds a predetermined threshold amount.

In still other embodiments, a system for providing funds to a customer upon the occurrence of one or more pre-determined events is provided. The system includes a first user computer connected to a network and configured to receive loan application input from a customer and a Product Implementation Server connected to the network. The Product Implementation Server is configured to receive information from, process, and transmit information to the first user computer via the network. In addition, the Product Implementation Server is configured to receive at least some of the loan application input from the first user computer, to receive information regarding a savings vehicle associated with the customer, and to calculate a periodic payment to be received from the customer based at least in part on the loan application information and a savings vehicle account balance. A guaranteed loan may be provided to said customer upon the occurrence of the one or more pre-determined events, and the guaranteed loan may be secured by the savings vehicle.

In some cases, the loan application input received by the Product Implementation Server includes a selection of at least one parameter by the customer. The periodic payment may be calculated based at least in part on the selection of the at least one parameter, and the at least one parameter may be selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit.

The first user computer may be configured to receive input from the customer changing the selection of the at least one parameter. The Product Implementation Server may be configured to adjust the periodic payment based on the input received changing the selection of the at least one parameter. In some cases, the Product Implementation Server includes a plurality of program modules selected from the group consisting of a Customer Election Module, a Benefit Distribution Election Module, a Benefit Collateralization Module, a Benefit Distribution Tracking Module, and a Benefit Recollection Tracking Module. The system may further include a second user computer connected to the network and associated with a provider of the guaranteed loan, wherein the second user computer is configured to provide the product provider with access to the information received, processed, and transmitted by the Product Implementation Server. The Product Implementation Server may be configured to transmit information to the first user computer via the network to provide the customer with access to real-time account information. In addition, the Product Implementation Server is configured to adjust the periodic payments when the savings vehicle account balance exceeds a predetermined threshold amount.

Further embodiments may include a method of providing funds to a customer upon the occurrence of one or more pre-determined events, where the method includes the steps of receiving one or more payments from said customer; associating said customer with a savings vehicle; and, in exchange for said one or more payments, providing a guaranteed loan to said customer upon the occurrence of said one or more pre-determined events, wherein said guaranteed loan is secured by the associated savings vehicle. The guaranteed loan may be a no interest loan or the loan may be provided to the customer at a below-market interest rate. The savings vehicle may be a savings account or a 401K account.

In some cases, an amount of at least one of said one or more payments may be based at least in part on a balance of funds within said savings vehicle. The savings vehicle may be a savings account, and an amount of at least one of said one or more payments may be based at least in part on a balance of funds within the savings account. A computer system may be used to calculate said one or more payments without assistance from a human user.

The one or more pre-determined events may comprise one or more events selected from a group consisting of involuntary unemployment of said customer, hospitalization of said customer, and disability of said customer. In some cases, selection of at least one parameter may be received from the customer. In addition, at least one parameter may be selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a Product Implementation System according to an exemplary embodiment;

FIG. 2 is a schematic diagram of a Product Implementation Server according to an exemplary embodiment;

FIG. 3 is a block diagram of a Product Implementation System according to an exemplary embodiment;

FIGS. 4A and 4B show a flow chart illustrating the relationship between a customer, an insurance company, and a financial institution, where the insurance company acts as a guarantor for the customer on a loan drawn from a financial institution according to an exemplary embodiment;

FIGS. 5A and 5B show a flow chart illustrating the relationship between a customer and an insurance company where the insurance company provides benefit payments directly to the customer according to another exemplary embodiment;

FIGS. 6A and 6B show a flow chart illustrating the relationship between a customer and a financial institution in which the financial institution provides benefit payments directly to the customer through a lending program according to another exemplary embodiment;

FIGS. 7A and 7B show a flow chart illustrating the relationship between a customer, an insurance company, and a financial institution where the financial institution provides benefit payments directly to the customer and purchases an insurance policy from the insurance company to cover losses experienced by the financial institution according to another exemplary embodiment;

FIG. 8 is a flow chart illustrating the functionality of a Customer Election Module according to an exemplary embodiment;

FIGS. 9A, 9B, and 9C illustrate a customer's premium payments, savings accumulation, fund distribution, and repayment for a particular covered event over a 60-month period according to one example;

FIGS. 10A, 10B, and 10C illustrate another customer's premium payments, savings accumulation, fund distribution, and repayment for a particular covered event over a 60-month period according to another example; and

FIG. 11 is an illustration of a customer interface according to an exemplary embodiment.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

### Brief Overview

Systems, methods, and computer program products according to various embodiments of the invention provide a financial product that provides customers with (1) the ability to build and preserve their savings; (2) a guarantee that they will have access to necessary funds during a time of need; and (3) an opportunity to leverage their hard-earned savings to secure a below-market or no interest loan at a time when other creditors would traditionally shy away from extending credit.

In particular, various embodiments of the invention guarantee customers access to a low or no interest loan that is collateralized against a pre-determined savings vehicle upon the occurrence of a pre-determined event, such as the involuntary unemployment, disability or hospitalization of the customer (or other predetermined event).

In various embodiments, the customer makes a payment on a financial product and at the same time makes a contribution towards his or her personal savings goal. The payment, for example, may be a premium for an insurance policy or a program fee for a lending program, as described below. The financial product in turn promises to provide the customer with access to a fixed or fluctuating cash benefit stream in the event that the customer experiences a life event specified in the policy. As the customer accumulates savings and the savings vehicle account balance exceeds a predetermined threshold, his or her loan is collateralized, which in turn may allow the insurance provider or third party lender to lower the payment (i.e., premium or program fee) that is required from the customer. In particular embodiments, the benefit payments are accumulated.

Upon the conclusion of the covered event, or sometime thereafter, the customer is expected to begin repaying all or a portion of the total funds received under the plan in the form of payments that may be distributed over a specified or fluctuating repayment period. In certain embodiments, during the payout and/or repayment periods, the customer may pay little or no interest on the amounts distributed.

In particular embodiments, a computer system may be used to facilitate the implementation of the financial product. This computer system may, for example, be adapted to calculate the appropriate premiums for the plan based, at least in part, on such factors as: (1) the customer's specific election of the amount of funds expected to be needed; (2) the customer's specific election of a savings goal; (3) the amount accumulated in the savings vehicle; (4) whether the customer wishes to withdraw from the savings amount; (5) the length of time over which the customer wishes to pay back the funds distributed; and (6) the customer's elected interest rate (for example, the customer may choose whether to pay 0%, 1%, or 2% interest on the distributed funds).

In various embodiments, the computer system tracks the accumulation of savings (e.g., a savings vehicle account balance), interest earned on the savings amount, percentage collateralized, payouts made to the customer, and the amounts to be paid back by the customer from the time of the first payout to the full collection of the amounts to be returned.

### System Architecture

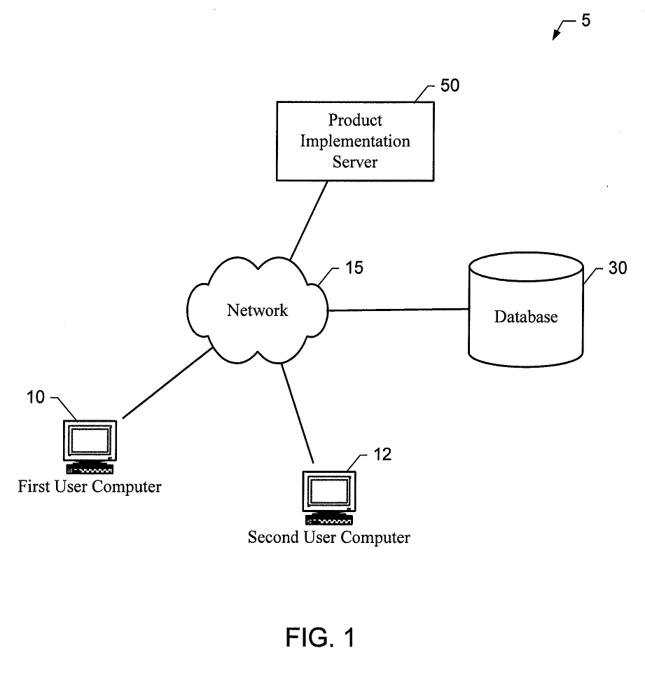

In various embodiments, a Product Implementation Computer System 5 is used to implement the alternative funding plan. One embodiment of a suitable Product Implementation Computer System 5 is shown in FIG. 1. As may be understood from this figure, in this embodiment, the system 5 includes one or more user computers 10, 12 that are connected, via a network 15 (e.g., a LAN or the Internet), to communicate with a Product Implementation Server 50. In a particular embodiment, the first user computer 10 is a computer associated with a customer, and the second user computer 12 is a computer associated with a product provider, such as an insurance company or a financial institution. In one embodiment of the invention, the Product Implementation Computer System 5 is configured for retrieving data from and storing data to a database 30 that may reside on (or, alternatively, as shown in FIG. 1, be stored remotely from) the Product Implementation Server 50.

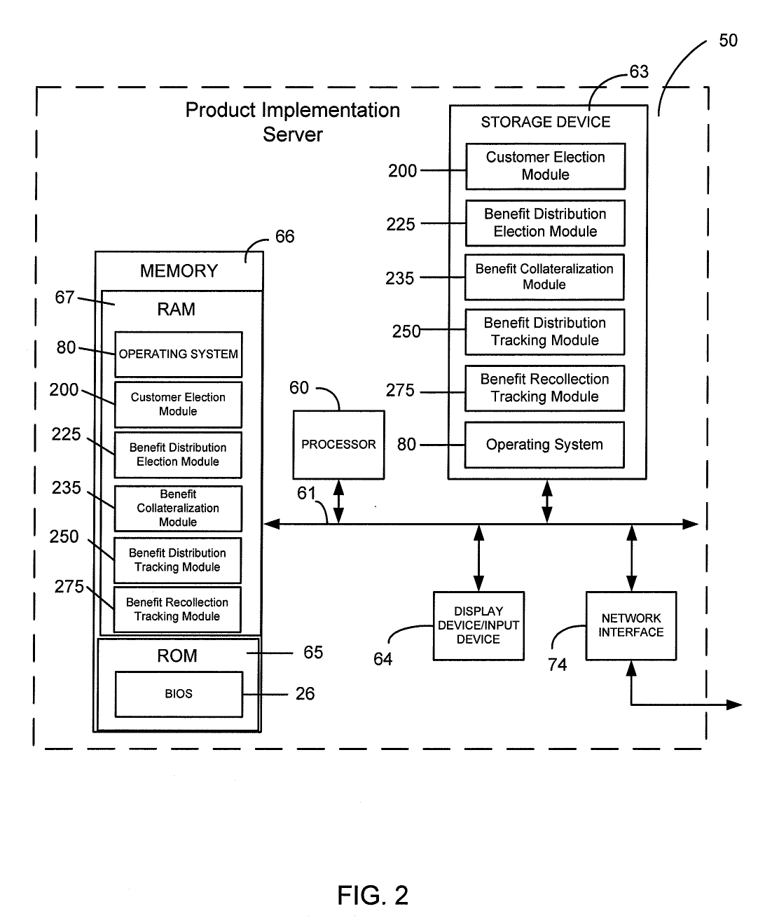

FIG. 2 shows a schematic diagram of a Product Implementation Server 50 according to one embodiment of the invention. The Product Implementation Server 50 includes a processor 60 that communicates with other elements within the Product Implementation Server 50 via a system interface or bus 61. Also included in the Product Implementation Server 50 is a display device/input device 64 for receiving and displaying data. This display device/input device 64 may be, for example, a keyboard, mouse, or pointing device that is used in combination with a monitor. The Product Implementation Server 50 may further include memory 66, which could include both read only memory (ROM) 65 and random access memory (RAM) 67. The server's ROM 65 may be used, for example, to store a basic input/output system 26 (BIOS) containing the basic routines that help to transfer information between elements within the Product Implementation Server 50.

In addition, the Product Implementation Server 50 may include at least one storage device 63, such as a hard disk drive, a floppy disk drive, a CD-ROM drive, or optical disk drive, for storing information on various non-transitory computer-readable storage media, such as a hard disk, a removable magnetic disk, or a CD-ROM disk. As will be appreciated by one of ordinary skill in the art in light of this disclosure, each of these storage devices 63 may be connected to the system bus 61 by an appropriate interface. The storage devices 63 and their associated computer-readable media may provide nonvolatile storage for a personal computer. It is important to note that the computer-readable media described above could be replaced by any other type of computer-readable media known in the art. Such media may include, for example, magnetic cassettes, flash memory cards, digital video disks, and Bernoulli cartridges.

A number of program modules may be stored by the various storage devices 63 and/or within RAM 67. Such program modules may include an operating system 80, a Customer Election Module 200, a Benefit Distribution Election Module 225, a Benefit Collateralization Module 235, a Benefit Distribution Tracking Module 250, and a Benefit Recollection Tracking Module 275. The Customer Election Module 200, the Benefit Distribution Election Module 225, the Benefit Collateralization Module 235, the Benefit Distribution Tracking Module 250, and the Benefit Recollection Tracking Module 275 may be configured to control certain aspects of the operation of the Product Implementation Server 50, as is described in more detail below, with the assistance of the processor 60 and the operating system 80.

Also located within the Product Implementation Server 50 is a network interface 74, for interfacing and communicating with other elements of a computer network. It will be appreciated by one of ordinary skill in the art in light of this disclosure that one or more of the Product Implementation Server 50 components may be located geographically remotely from other Product Implementation Server 50 components. Furthermore, one or more of the components may be combined, and additional components performing functions described herein may be included in the Product Implementation Server 50.

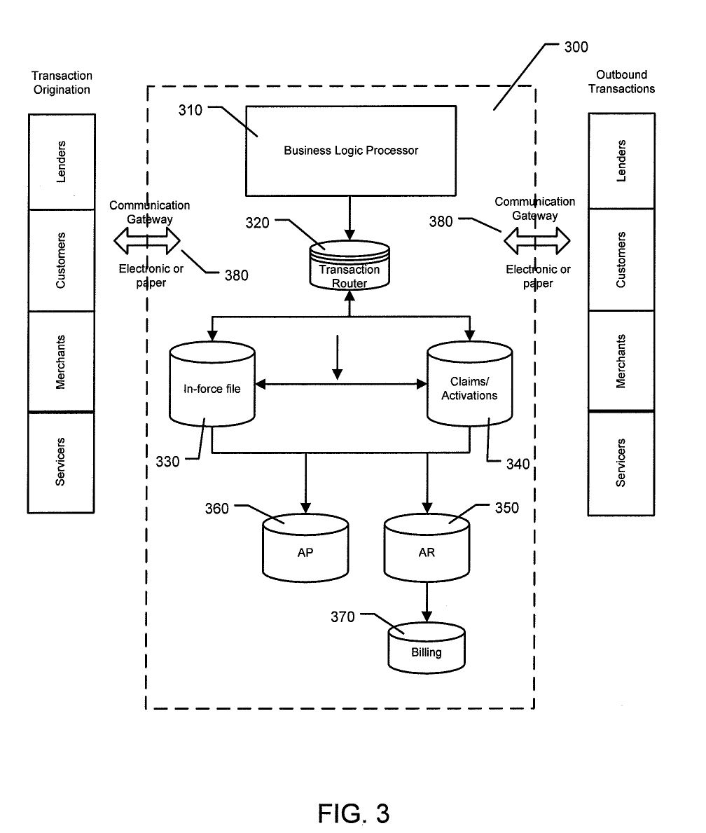

Another embodiment of a system is shown in FIG. 3. In this embodiment, the Plan Implementation System 300 includes a Business Logic Processor 310 that is configured to receive and process transaction information and for passing the information to a Transaction Router 320, which routes information regarding the transaction to various other components of the system 300 for processing. The system 300 may further include an In-Force File 330, which may be, for example, a database or file that stores a listing of plans/policies that are currently in force. The system 300 may also include a Claims/Activations Server 340 that is configured for processing activations of new plans/policies and for processing claims filed under those policies.

In this embodiment, the system 300 may also include an Accounts Receivable (AR) Server 350 and a Billing Server 370, which are configured, respectively, to handle accounts receivable information and to process bills. In addition, the system 300 may include an Accounts Payable (AP) Server 360 for handling accounts payable.

In particular embodiments, the system 300 may also include a communication gateway 380 that is configured to facilitate communications between the system 300 and, for example, servicers, merchants, customers, and/or lenders. The communication gateway 380 may, for example, be configured to handle the following types of inbound transactions and information: (1) new enrollments; (2) information regarding new insureds; (3) customer loan information; (4) customer instructions/selections on savings goals and cash disbursements; (5) billing transactions; and (6) debt history information. The communication gateway 380 may, for example, be configured to handle the following types of outbound transactions and information: (1) fulfillment package information; (2) confirmations of customer instructions/selections; (3) requests for benefit communications; (4) payments; (5) billing; and (6) customer service communications.

### More Detailed Discussion of Various Embodiments

Various embodiments of the invention are described in greater detail below. These embodiments include: (1) an insurance policy embodiment in which the funds are paid by a specified lender other than the insurance company offering the policy; (2) a pure insurance policy embodiment; (3) a lending program embodiment; and (4) a lending program embodiment with default coverage for the lender.

Insurance Policy Embodiment—Customer Interacts with Insurance Company, Insurance Company Obtains Loan Funding from Financial Institution

In particular embodiments, the customer pays periodic premiums (e.g., monthly premiums) for an insurance policy in which an insurance company promises to act as guarantor for the customer on a loan that can be drawn from one or more specified financial institutions (e.g., other than the insurance company) in the event that the customer experiences a covered event such as, for example: (1) the unemployment of a specified individual; (2) the birth of a specified individual's child; (3) the adoption of a child by a specified individual; (4) the disability of a specified individual; and/or (5) the death of a specified individual, as specified in the policy. In particular embodiments, the specified individual is the policy holder.

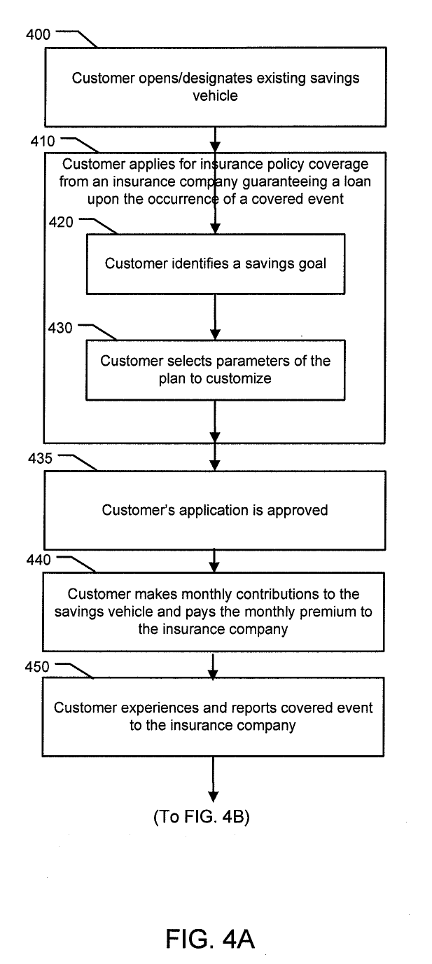

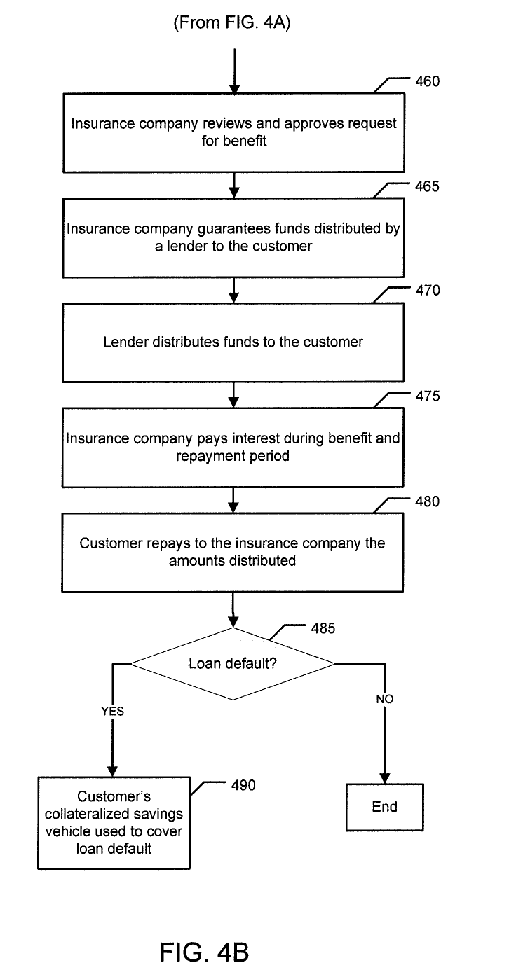

Various exemplary steps associated with this embodiment are shown in FIGS. 4A and 4B. As shown in FIG. 4A, beginning at Step 400, the customer establishes a savings vehicle with a financial institution. The savings vehicle may be, for example, a savings account, a Certificate of Deposit (CD), a money market account, an Individual Retirement Account (IRA), or a 401K account, among other things. In addition, the savings vehicle may be a new savings vehicle established for the purpose of obtaining this particular financial product, or the savings vehicle may be pre-existing, in which case the customer would designate the savings vehicle for the program.

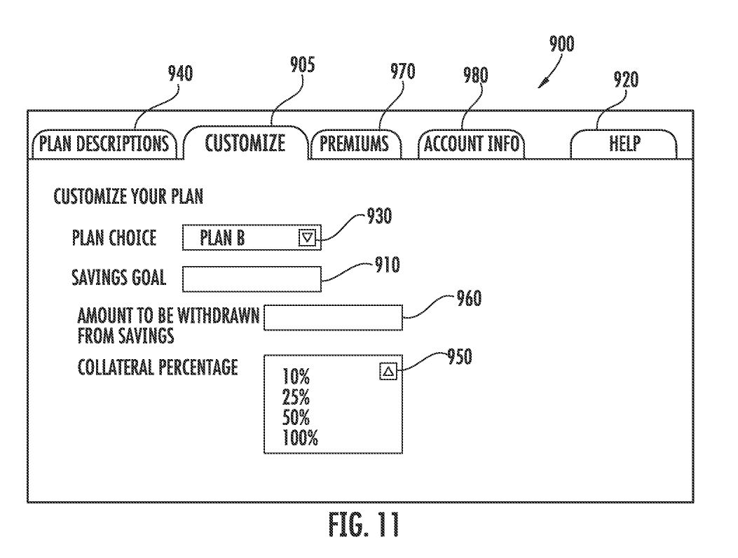

In the case of a new savings vehicle, the customer may access a web-based interface via the first user computer 10 (shown in FIG. 1) that is supported by the insurance company via the second user computer 12. The interface may provide information to assist the customer in identifying the most appropriate savings vehicle, for example by providing statistical information, interest rates, benefit choices, benefit descriptions, estimated premiums, educational articles, etc. An example of a customer interface 900 is shown in FIG. 11. The customer interface may be accessible through the insurance company's website, or in some embodiments may be accessible via a link from the financial institution's website to the insurance company's website (e.g., the financial institution with which the customer has established a savings vehicle).

Next, at Step 410 of FIG. 4A, the customer applies for insurance policy coverage from an insurance company. If approved, the insurance company acts as a guarantor for a loan issued by the financial institution to the customer if the specified (covered) event occurs. The insurance company may act as a guarantor for the interest portion of the loan, the principal portion of the loan, or both the interest and the principal portions of the loan. In one embodiment, the nature of such guarantor obligations would be determined based on terms negotiated between the financial institution and the insurance company.

As part of the step of applying for insurance policy coverage, the customer should identify a savings goal at Step 420. For example, the customer may be prompted (e.g., by the web interface 900 via a text box 910 in FIG. 11) to identify a savings goal amount. In some embodiments, the customer may use the web-based interface 900 mentioned above to help him identify the savings goal amount. Again, information may be available to the customer via the interface to assist the customer in identifying the goal, for example, under a Help tab 920. In this regard, a savings “calculator” may request input from the customer regarding his age, salary, and monthly expenses, among other things, and apply an algorithm to the data to determine a range of appropriate savings goal amounts for the particular customer. In other cases, the customer may already have a savings goal in mind. For instance, another customer may want to have an equivalent of 3-6 months salary in a “rainy day” fund.

In various embodiments, goal setting is an important tool in the process because: (A) it provides structure for the building of equity within customer savings vehicles; (B) the more equity customers build, the more affordable the financial product becomes for them; and (C) by proactively planning for an event, customers are more cognizant of their financial needs. In particular embodiments, the identified savings vehicle is used as collateral for the loan and, as such, in various embodiments, appropriate processes for pledging such funds are initiated.

In some embodiments, for example, where a savings vehicle is preexisting, the savings goal may be based on an amount that exceeds an amount already held in the savings vehicle account. In another embodiment, a savings goal may be selected that is actually equal to or less than an amount already existing in the savings vehicle account, at which point a selected loan or benefit may be sufficiently collateralized as described in greater detail below.

Once the savings goal is identified, the customer has the flexibility to select various parameters of the plan to customize the plan to meet his personal needs at Step 430 of FIG. 4A. In some embodiments, referring again to FIG. 11, the web-based interface 900 may prompt the customer to elect a particular policy coverage benefit level, covered event(s), monthly savings contribution amount, and/or the timeframe for repaying the loan once a disbursement is made. Other parameters that may be selected include the interest rate of the guaranteed loan, the deferral period for loan repayment, the repayment period, the amount of the guaranteed loan, and the term limit associated with the policy. The term limit may dictate when the customer should re-apply for coverage or may require that at pre-determined frequencies the customer's policy and/or credit-worthiness be re-evaluated and, as a result, that the policy premium amount, repayment terms, or interest rate be adjusted or rewritten.

As further examples, one policy may provide an option for a customer to, upon the occurrence of a qualifying event, receive a loan at a variable rate that is based upon the current Prime Rate or other index. Another policy may provide an option for a customer to, upon the occurrence of a qualifying event, receive a loan at a variable rate that is based upon the current Prime Rate or other index plus or minus a pre-established rate.

Still another policy may provide an option for a customer to select a deferral period (e.g., the number of months the loan repayments can be deferred if the customer remains unemployed). The deferral could be calculated either from the original event or, assuming the maximum deferral period has not been reached, the deferral could be used for secondary events. In an example scenario, Customer A becomes unemployed for 3 months and receives 3 payouts. Customer A goes back to work for 120 days and then becomes unemployed again. Customer A is unemployed the second time for 2 months and makes a claim for 2 payouts. At the time of the second event, under this type of policy, Customer A may have the option to defer the repayment from the first unemployment claim period.

Other options that may be available to a customer, depending on the policy or plan chosen, include an option for a customer to, upon the occurrence of a qualifying event, receive a loan where the amount of the loan is based on an average monthly outflow from an account associated with the customer. Another option may be for a customer to, upon the occurrence of a qualifying event, receive a loan where the amount of the loan is based on a monthly inflow of funds, e.g., from a specified source, into an account associated with the customer. Yet another option may allow the customer to, upon the occurrence of a qualifying event, receive a loan where the amount of the loan is based on specified bills associated with the customer.

Still other options that may be selectable by the customer include the option to select the amount of the loan to be repaid, the repayment period, and the interest rate. Selection of one or more of the options described above may be used to determine the cost of the program to the customer. In other words, the periodic premiums to be paid by the customer for the coverage may be adjusted based on the options selected. A customer may also be able to select from a series of options to build a benefit package specific to their needs in which the benefits are a combination of cash payouts that the customer will keep and cash payouts that the customer is expected to return. Furthermore, in some cases, the customer may have the option to allow the system to select the premium, the loan amount period, and the interest rate variables for the customer at the time of application based on the quality of the customer (e.g., the customer's credit score or other factors reflecting the customer's ability to repay the loan).

Referring to FIG. 11, the customer may be prompted to select a particular plan via a drop down box 930 under a Customize tab 905, and further policy coverage information and selections may be available under a Plan Descriptions tab 940. For example, a table summarizing various features or benefit options of each plan choice may be provided under the Plan Descriptions tab 940, as illustrated in Table A, below. The customer may also elect a collateralized amount, i.e., the amount of savings (or percentage of the loan) for which the customer wishes to collateralize the loan, to secure a reduced policy premium, for example through another drop down box 950. The loan may be a 0% interest loan, a below-market rate loan, or the loan may be based on the customer's credit score at the time of the occurrence of the qualifying event.

TABLE A

| Event | Product-Type | Benefit |
|---|---|---|
| Disability, | Loan | A low interest loan |
| Hospitalization, | | equivalent to the Need |
| Involuntary | | Amount (based on customer- |
| Unemployment | | specified savings goal and |
| | | risk tolerance level). |
| | | Repayment begins after |
| | | benefit period is over. |
| Long-Term Care | Insurance | The Need Amount (based on |
| | | customer-specified savings |
| | | goal and risk tolerance level) |
| | | is disbursed in equal |
| | | monthly payments over a |
| | | period of time. Funds saved |
| | | to date are returned to the |
| | | customer. No repayment. |
| Life | Insurance | A lump-sum payment equal |
| | | to 2× the Need Amount |
| | | (based on customer- |
| | | specified savings goal and |
| | | risk tolerance level) is |
| | | disbursed. Funds saved to |
| | | date are returned to the |
| | | customer. No repayment. |

In addition, the customer may be asked (e.g., by the web-based interface 900 via text field 960) to specify whether, during a time of need, he would be willing to tap into his savings vehicle (at least in part), or whether his goal is to leave his savings completely untouched.

Based on the selected parameters, for example the parameters selected under the Customize tab 905 described above, and in addition to other typical loan application information provided by the customer, the insurance company would determine whether to approve the customer for the particular coverage requested. For example, in some embodiments, the insurance company may communicate with third parties (e.g., the customer's employer, a credit agency, a financial institution, etc.) to verify certain application information or obtain data that would inform the insurance company regarding the risk involved in extending the loan guarantee. Such communication, for example, may occur between the parties through their respective servers and/or databases. The insurance company may approve the customer based on its own criteria or based on previously agreed to terms determined by the insurance company and the financial institution.

In some embodiments, the insurance company may associate approval of a customer with a certain range of premiums, such that adjustment of the customer's premium over time is within the pre-approved range. The customer's premium may be at a higher or lower end of the pre-approved range based on the benefits selected, the savings vehicle account balance, the collateralized amount, and/or other options selected by the customer, as described below. The customer may be allowed to view estimated premiums based on the selections made (and pending formal approval described above) under a Premiums tab 970, shown in FIG. 11. After the application is approved, the Premiums tab 970 may show actual premiums or premium ranges.

In various embodiments, premiums for the financial product are designed to take into consideration that, because the loan is collateralized, the risk to the provider of the financial product (in this case, the insurance company) decreases as the equity in the selected savings vehicle builds and, as such, both monthly premiums and payback interest rates may be lower than those of standard loans. Additionally, in various embodiments, customers that have some tolerance for risk and are willing to dip into their savings while under hardship would see the additional benefit of reduced premium payments over time. In other words, they would have to borrow less and their premium payments would gradually decrease as their collateral builds past their point of need. In various embodiments, the Benefit Collateralization Module calculates these premium payments automatically on a periodic basis, as described below.

Once the customer has made these choices and has been approved at Step 435 of FIG. 4A, he can start making monthly contributions to the savings vehicle and pay the monthly premium to the insurance company at Step 440. In some embodiments, the financial institution transmits the monthly balance of the savings vehicle to the insurance company, and the insurance company bills the customer for the monthly premium. As noted above, the monthly premium may change from month to month as the amount in the savings vehicle grows. In other embodiments, the monthly premium is automatically distributed to the insurance company by the financial institution holding the savings vehicle by drawing a portion of the monthly contributions to the savings vehicle.

Later, at Step 450, the customer experiences, and reports, a covered event to the insurance company (e.g., by electronically transmitting a request for benefit via the Product Implementation System). At Step 460 of FIG. 4B, the insurance company reviews the customer's request for benefits under the plan and, if appropriate, approves the request for benefit. At Step 465, the insurance company guarantees the funds distributed by a lender (e.g., a financial institution) to the customer for the covered event, and, at Step 470, the funds are distributed to the customer (and/or to other entities specified by the customer) during the benefit period. Thus, in this embodiment, although the insurance company is the product provider, the financial institution acts as the lender.

During the benefit and loan repayment periods, the insurance company may pay the interest on the loan to the lender at Step 475. After the benefit period ends, the repayment period begins. During this repayment period, at Step 480, if called for under the plan, the customer would repay to the insurance company the amounts distributed in accordance with the plan's repayment terms. If the customer does not repay any portion of the loan at Step 485, however, the customer's collateralized savings vehicle is used to cover the loan default, at Step 490. Thus, the customer's ability to withdraw from the savings vehicle may be frozen to protect against the customer's withdrawal of the collateralized portion during all or part of the customer's participation in the program.

Pure Insurance Policy Embodiment—Customer Interacts with Insurance Company, Insurance Company Provides Loan Funding Directly

In particular embodiments, the customer pays periodic premiums (e.g., monthly premiums) for an insurance policy in which the insurance company agrees to provide payments directly to the customer in the event that the customer experiences a covered event such as, for example: (1) the unemployment of a specified individual; (2) the birth of a specified individual's child; (3) the adoption of a child by a specified individual; (4) the disability of a specified individual; and/or (5) the death of a specified individual, as specified in the policy. In particular embodiments, the specified individual is the policy holder.

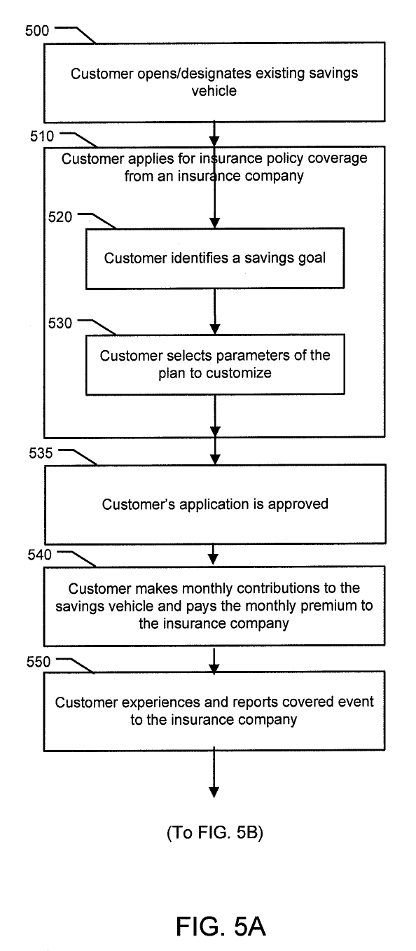

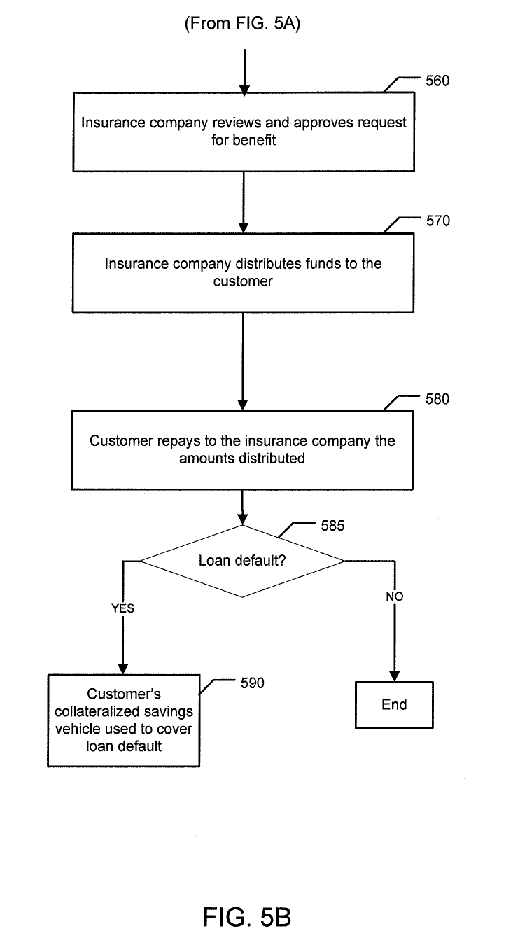

Various exemplary steps associated with this embodiment are shown in FIGS. 5A and 5B. As shown in FIG. 5A, and similar to embodiments in which funds are paid by a financial institution, beginning at Step 500, the customer establishes a savings vehicle with a financial institution or designates an existing savings vehicle for the program.

Next, at Step 510, the customer purchases insurance policy coverage from an insurance company. The customer again identifies a savings goal at Step 520, for example through interaction with a web-based interface 900 (shown in FIG. 11 and described above) that facilitates the process. As with previous embodiments, once the savings goal is identified, the customer has the flexibility to select various parameters of the plan to customize the plan to meet his personal needs at Step 530.

Once approved at Step 535 (as described above), the customer then starts making monthly contributions to the savings vehicle and pays the monthly premium to the insurance company at Step 540. As noted above, the monthly premium calculated by the insurance company may change from month to month as the amount in the savings vehicle grows.

At Step 550, the customer experiences, and reports, a covered event to the insurance company. At Step 560 in FIG. 5B, the insurance company reviews the customer's request for benefits under the plan and, if appropriate, approves the request for benefit. Because in these embodiments the insurance company is issuing the loan directly to the consumer, a third-party lender is not involved in the loan disbursements. Rather, the insurance company distributes the funds to the customer (and/or to other entities specified by the customer) during the benefit period at Step 570. Thus, in this embodiment, the insurance company acts as both the product provider and the actual lender.

After the benefit period ends, the repayment period begins. During this repayment period, at Step 580, if called for under the plan, the customer would repay to the insurance company the amounts distributed in accordance with the plan's repayment terms. If the customer does not repay any portion of the loan at Step 585, however, the customer's collateralized savings vehicle may be used to cover the loan default, at Step 590.

Financial Institution Loan Embodiment—Customer Interacts with Financial Institution, Financial Institution Provides Loan Funding Directly

In certain embodiments, the customer pays fees to a financial institution, such as a bank, to secure a loan in which the distribution of loan proceeds is limited and/or conditioned upon the occurrence and/or continuation of a specified covered event such as, for example: (1) the unemployment of a specified individual; (2) the birth of a specified individual's child; (3) the adoption of a child by a specified individual; (4) the disability of a specified individual; and/or (5) the death of a specified individual, as specified in the policy. In particular embodiments, the specified individual is the policy holder.

In various embodiments, the customer may elect a specified payback period and an interest rate to be applied to the loan during the benefit payout and repayment period. The interest rate can be, for example, 0% or greater. In particular embodiments, the customer can elect one or more terms of their coverage (e.g., the interest rate, the amount of the loan to be ultimately repaid by the customer, the benefit amount, or the payback period) via the web-based interface 900 (described above and shown in FIG. 11).

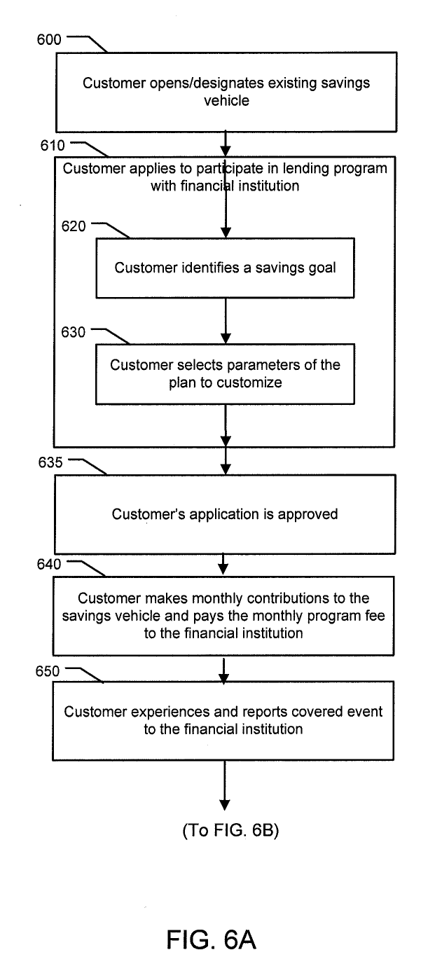

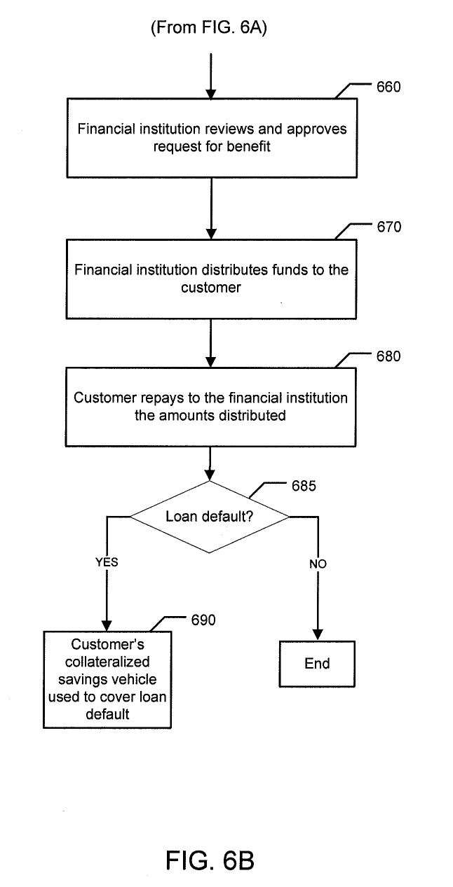

Various exemplary steps associated with this embodiment are shown in FIGS. 6 A and 6B. As shown in FIG. 6A, and similar to embodiments in which the insurance policy is issued by the insurance company and the funds are paid directly by the insurance company, beginning at Step 600, the customer establishes a savings vehicle with the financial institution or designates an existing safety vehicle for the program.

Next, at Step 610, the customer applies to participate in a lending program in which the financial institution guarantees the loan to the customer upon the occurrence and/or continuation of the specified covered event. In other words, if approved, the financial institution agrees to extend credit to the customer in the event that the customer experiences an event that is covered by the lending program. As with previously described embodiments, as part of the application process, the customer identifies a savings goal at Step 620, for example through interaction with a web-based interface that facilitates the process. In this case, the web-based interface 900 may be supported and/or maintained by the financial institution rather than an insurance company. As with previous embodiments, once the savings goal is identified, the customer can also select various parameters of the plan to customize the plan at Step 630. The financial institution would then determine whether the customer's application is approved and, in some embodiments, define a range of premiums to be applied to the customer, as described above.

Once approved, the customer then starts making monthly contributions to the savings vehicle and pays a monthly (or otherwise periodic) program fee to the financial institution at Step 640. In this case, the monthly program fee may be calculated by the financial institution based at least in part on the plan parameters selected by the customer and the savings vehicle account balance. Thus, the monthly program fee may change from month to month as the amount in the savings vehicle grows.

At Step 650, the customer experiences, and reports, a covered event to the financial institution. At Step 660 in FIG. 6B, the financial institution reviews the customer's request for benefits under the plan and, if appropriate, approves the request for benefit. The financial institution then distributes the funds to the customer (and/or to other entities specified by the customer, such as credit card companies, mortgage holders, and other creditors, etc.) during the benefit period at Step 670. Thus, in this embodiment, the financial institution acts as both the product provider and the lender.

After the benefit period ends, the repayment period begins. During this repayment period, at Step 680, if called for under the plan, the customer would repay to the financial institution the amounts distributed in accordance with the plan's repayment terms. If the customer does not repay any portion of the loan at Step 685, however, the customer's collateralized savings vehicle is used to cover the loan default, at Step 690.

Loan with Default Coverage Embodiment—Customer Interacts with Financial Institution, Financial Institution Obtains Insurance Policy from Insurance Company

In certain embodiments, the customer pays fees to a financial institution to secure a loan in which the distribution of loan proceeds are limited and conditioned upon the occurrence and/or continuation of a specified life event, such as one of the events described above. The financial institution purchases an insurance policy from an insurance company safeguarding against losses for the loan program, such as default coverage on the amounts loaned by the financial institution to the customer under the terms of the program. In particular embodiments, this insurance policy also pays the financial institution interest credits that serve to buy down the interest charged on the monies lent to the customer. The policy may also pay the financial institution interest accumulated on the loan by the customer.

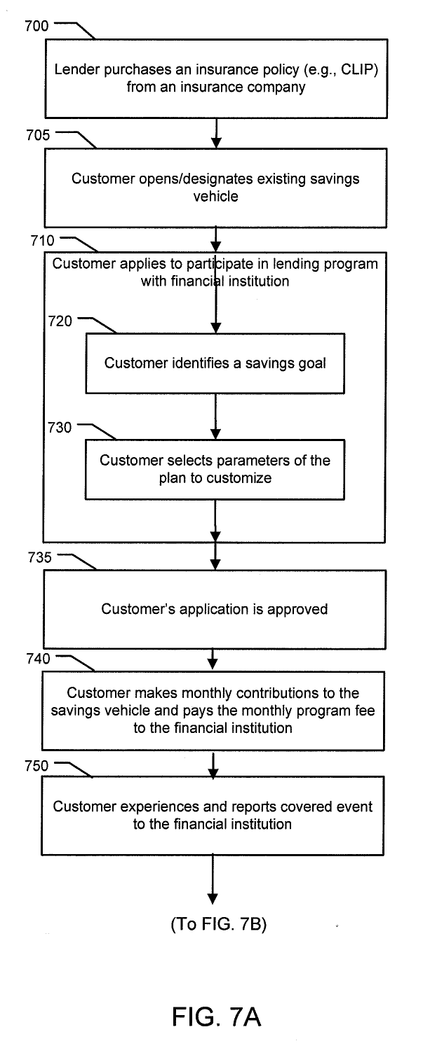

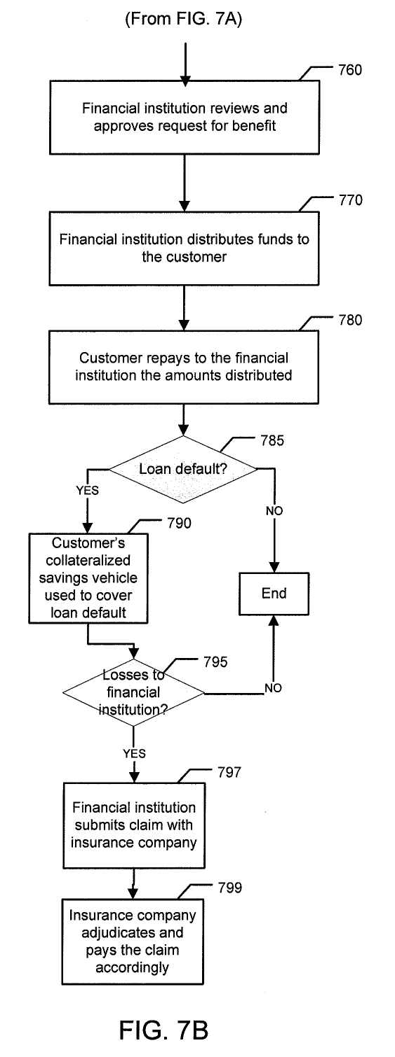

Various steps associated with this embodiment are shown in FIGS. 7A and 7B. In FIG. 7A, beginning at Step 700, the lender purchases an insurance policy from an insurance company, such as a Contractual Liability Policy (CLIP), safeguarding against losses that the lender may incur by extending credit to customers, under the program, as a result of the occurrence of various covered events. Later, at Step 705, the customer opens a savings vehicle with the financial institution or designates an existing safety vehicle for the program. At Step 710, the customer applies to participate in a lending program in which the financial institution guarantees a loan to the customer upon the occurrence and/or continuation of the specified covered event. In other words, the financial institution agrees to extend credit to the customer in the event that the customer experiences an event that is covered by the lending program.

As with previously described embodiments, as part of the application process, the customer identifies a savings goal at Step 720, for example through interaction with a web-based interface 900 (shown in FIG. 11) that facilitates the process. As with the previous embodiment, the web-based interface may be supported and/or maintained by the financial institution rather than an insurance company. Once the savings goal is identified, the customer can select various parameters of the plan to customize the plan at Step 730.

Upon approval by the financial institution at Step 735, the customer then starts making monthly contributions to the savings vehicle and pays a monthly program fee to the financial institution at Step 740. In this case, the monthly program fee may be calculated by the financial institution based on the plan parameters selected by the customer and the balance of funds in the savings vehicle. Thus, the monthly program fee may change from month to month as the amount in the savings vehicle grows.

At Step 750, the customer experiences, and reports, a covered event to the financial institution. At Step 760 in FIG. 7B, the financial institution reviews the customer's request for benefits under the plan and, if appropriate, approves the request for benefit. The financial institution then distributes the funds to the customer (and/or to other entities specified by the customer) during the benefit period at Step 770. Thus, in this embodiment, the financial institution again acts as both the product provider and the lender.

After the benefit period ends, the repayment period begins. During this repayment period, at Step 780, if called for under the plan, the customer would repay the amounts distributed to the financial institution in accordance with the plan's repayment terms. If the customer does not repay any portion of the loan at Step 785, the customer's collateralized savings vehicle is used to cover the loan default, at Step 790.

If, at Step 795, a determination is made that the customer has not repaid on schedule, then the financial institution may submit a claim to the insurance company based on the CLIP at Step 797. At Step 799, the insurance company adjudicates and pays the claim in compliance to policy requirements. For example, if the customer's collateralized savings is not enough to cover the loan default amount, the financial institution may be able to obtain the deficit from the insurance company under the terms of the CLIP.

### Additional Features of Various Embodiments

In particular embodiments, the computer system tracks various components of the program so as to separate the component parts into their appropriate regulatory components such as lending and insurance for various purposes including compliance with state and federal law. Also, in various embodiments, the customer is able to select (e.g., via the Product Implementation System 300) from a series of options to build a benefit package specific to their needs in which, for example, the benefits may include a combination of cash payouts that the customer will keep and cash payouts that the customer is expected to return.

In another embodiment, the customer is able to select at the time of enrollment from various methodologies to be used to determine the amount of coverage the customer will receive in any given month. In one example, a customer may be given the option to tie their benefit levels to their monthly cash outflow from their checking account. In another example, the customer is given the option to tie the benefit levels to a percentage of monthly cash inflow from an employer through their checking account. In another example, the customer is given the option to select specific bill payments that will be used to determine the appropriate benefit amount.

In various embodiments, the customer accesses the computer system to direct the insurance company or financial institution on how to distribute the proceeds from the amounts paid during a particular, qualified claim period. In particular embodiments, the system takes the specific direction from the customer and/or provides options to the customer to assist them in optimizing the use of the funds. In some cases, the system allows the customer to dynamically change benefit selections, collateral amounts, and other parameters and adjusts the monthly premium or program fee accordingly, for example, within the pre-determined range of premiums. For example, the customer may be allowed to access the web-based interface 900, shown in FIG. 11, at certain times during the life of the plan or throughout the life of the plan to change options or previously made selections. The customer may also be able to view real-time account information reflecting the amount collateralized so far, the savings vehicle account balance, etc., for example through an Account Info tab 980.

### Exemplary Software Modules

In particular embodiments, the functionality described above is executed by a computer system running the various exemplary software modules described below. It should be understood that these modules are exemplary and that other types of software modules could be used in alternative embodiments.

Customer Election Module: In particular embodiments, this module presents customers with options for: (1) assessing their needs in regard to the program (e.g., what their savings goal is, how much of a loan they will require upon the occurrence of a covered event, and how much of their savings they are willing to draw from upon the occurrence of the covered event); (2) selecting the appropriate coverage selections to meet those needs; and (3) determining which portion of the benefit distributions made under a covered event will be repaid to the insurance company or financial institution and which portion will not require repayment. In addition, the Customer Election Module 200 may be adapted to: (1) allow users to specify a repayment schedule for repaying any funds that are to be repaid; and (2) if applicable, allow users to specify how the interest is to be calculated on any interest-bearing portions of the funds. The Customer Election Module may further be configured to allow the customer to change or adjust his elections after the plan has been set up. It should be understood that this module may include a graphical user interface, a web-based interface 900 (see FIG. 11 and associated description above), or other suitable interface, for exchanging information with the customer, for example, over the Internet.

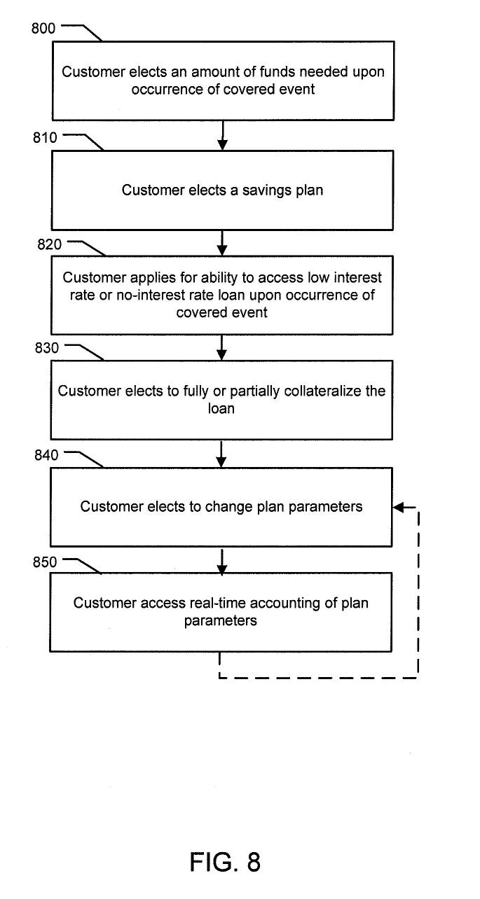

FIG. 8 shows in more detail the various operations that may be executed through the Customer Election Module in some embodiments. In some embodiments, a customer who desires to protect against income loss in the event of involuntary unemployment, disability, hospitalization, and/or some other covered event may access the Customer Election Module through a web-based interface via the Internet, for example, through an insurance company's website. At Step 800, the customer uses the Customer Election Module to elect an amount of funds he would need to get him through the covered event. At Step 810, the customer further elects a savings plan (e.g., how much money the customer plans to accumulate in the savings vehicle) and elects whether and what percentage of the saved funds the customer is willing to withdraw upon the occurrence of the covered event.

To fill the gap between the funds saved and the funds needed upon the occurrence of the covered event, the customer applies for the ability to access a low interest rate or no-interest rate loan upon the occurrence of the event at Step 820. As described above, this may be done in several ways, such as by applying for and purchasing an insurance policy, where either the insurance company acts as the guarantor for a loan obtained from a financial institution or provides the loan directly to the customer, or by applying for and participating in a lending program offered by a financial institution, where the financial institution may purchase an insurance policy (such as a CLIP) from an insurance company to cover any losses. At Step 830, in some embodiments, the customer has the option to elect to reduce his monthly premium/program fee by allowing the balance of funds in his savings vehicle to fully or partially collateralize the loan.

As described above, once the customer is approved for the insurance policy/lending program, the customer opens a savings vehicle (if not using an existing savings vehicle) and contributes funds periodically (e.g., monthly), thus, building the funds towards his savings goal. The customer also pays the periodic premium/lending program fee.

At Step 840, the customer may elect to change savings contribution amounts, the collateralized amount or loan benefit amounts during the life of the coverage. For example, as the funds in the savings vehicle build, the customer may adjust his election of a collateralized percentage from collateralizing 75% of the loan amount to collateralizing 100% of the loan amount. As a result, the customer may see a reduction in the monthly premium/program fee imposed. Finally, at Step 850, the customer may use the Customer Election Module to access and review a real-time accounting of his savings balance, benefit levels, loan amounts available, outstanding loan amounts, repayment terms and status, etc. As with previously described figures, the steps shown do not necessarily represent a chronological order of the steps. Thus, the steps may occur in any order and may occur simultaneously, in some cases. For example, upon reviewing a real-time accounting of the details of the program at Step 850, the customer may elect to adjust one or more parameters at Step 840.

Benefit Distribution Election Module: In particular embodiments, the Benefit Distribution Election Module 225 captures the customer's election for benefit distributions. In various embodiments, this module receives detailed information from the customer regarding the customer's outstanding financial obligations. The module then uses a suitable optimization algorithm to determine an optimized approach for repaying the various financial obligations. The system then provides the customer with recommendations on how to set up their fund distributions according to this optimized approach.

Benefit Collateralization Module: In particular embodiments, the Benefit Collateralization Module 235 analyzes the parameters of the customer's elections made via the Customer Election Module 200, considers the real-time accounting of one or more of the customer's savings balance, benefit levels, loan amounts available, outstanding loan amounts, repayment terms and status, etc., and applies a suitable optimization algorithm to determine an appropriate monthly premium or program fee for the customer. In other words, as the risk to the lender (e.g., the insurance company or the financial institution) decreases, the amount of the premium or program fee may be reduced accordingly, for example, within a pre-approved range. Thus, as demonstrated in the various examples provided below, as the amount of funds accumulates in the customer's savings vehicle, a smaller monthly premium or program fee maybe required. Similarly, if the amount in the customer savings vehicle surpasses the amount of the loan to be extended upon the occurrence of a covered event (e.g., the loan would be fully collateralized), then the amount of the monthly premium or program fee may be reduced according to the algorithm.

Benefit Distribution Tracking Module: In certain embodiments, this module tracks all benefit distributions made to the customer and properly categorizes them according to the nature of the distribution and expectation for repayment by the customer. In particular embodiments, the Benefit Distribution Tracking Module 250 also tracks outstanding distributions to determine interest payments: (1) to be paid either by the customer or the insurance company; or (2) to be forgiven by the lender directly over the distribution period. In various embodiments, the Benefit Distribution Tracking Module 250 tracks those portions of fees and premiums considered insurance or lending for regulatory purposes.

Benefit Recollection Tracking Module: In particular embodiments, the Benefit Recollection Tracking Module 275 tracks total outstanding benefit distributions expected to be repaid by the customer over the benefit collection period. In various embodiments, this module calculates the related interest amounts to be paid by the insurance company or lender to determine total benefit cost. This module may also calculate any penalty interest to be paid by the customer if the customer defaults on any or all of the repayment schedule.

### EXAMPLES

As noted above, in various embodiments, the customer pays a monthly premium or fee for an insurance policy or other financial product that promises to provide the customer with a specified or fluctuating cash benefit stream in the event that the customer experiences a covered event specified in the policy. In particular embodiments, the benefit payments are accumulated. Upon the conclusion of the triggering event, at sometime thereafter, or at some other time, the customer is expected to begin paying all or a portion of the total amounts distributed over a specified or fluctuating repayment period. In particular embodiments, during the payout and/or repayment periods, the customer pays little or no interest on the amounts distributed. In other embodiments, the customer may pay market interest rates.

As described above, in particular embodiments, the system calculates the appropriate premiums based on the customer's specific election to: (1) collateralize all or a portion of the loan; (2) withdraw a portion of the necessary funds from the savings vehicle; (3) either pay back all or a portion of the amounts distributed; and/or (4) pay 0% or more interest on the distribution. The system tracks the accumulation of savings, payouts, and the amounts to be paid back from the customer from the time of the first contribution to the savings vehicle, to payout to the customer, to the full collection of the amounts to be returned.

Below are two exemplary scenarios of a financial product according to various embodiments of the invention. It should be understood that the rates shown are for exemplary purposes only and that any suitable rate structures may be used.

### Example 1

### “Katherine Wright”

TABLE B
Customer Profile for “Katherine Wright”

| | |
|---|---|
| Rainy Day Savings Goal | $6,000 |
| Risk Tolerance | Doesn't want to touch her savings at all; wants coverage for |
| | the full $6,000 |
| Program Options | Disability, Hospitalization, and Involuntary Unemployment |
| | coverage in the amount of 2× savings goal (i.e., $12,000) |
| Disbursement Options | Equal Installments Over 6 Months |
| Repayment Terms | 36 Months |
| Monthly Savings Goal | $250 |

As shown in Table B above, Katherine has determined that she needs about $6,000 over a 6-month period to cover her financial obligations in the event that she becomes unemployed, disabled or hospitalized. She does not, however, feel comfortable dipping into her savings account at all, so she is looking for the financial product to cover her for the complete $6,000. This way, Katherine's savings can remain intact and continue to accrue interest should she become disabled, hospitalized, or involuntarily unemployed, and she will have her savings available as a last resort if she needs it. To work towards her goals, Katherine plans on saving $250 per month.

In some embodiments, the insurance company (or other provider) reviews information input by Katherine (e.g., via the Customer Election Module) and determines which program parameters are to be offered to Katherine. In various embodiments, Katherine can only choose among the program parameters that are offered by the provider.

Katherine is approved and starts saving towards her goal and paying the monthly premium for the financial product (the financial product in this particular case being an insurance policy, according to one of the embodiments described above). Katherine will see a decrease in premiums over time as her savings begin to collateralize a larger portion of her potential financial product loan obligation. The decreased premiums may be calculated automatically (e.g., by the Benefit Collateralization Module described above). In various embodiments, any amount saved beyond the $6,000 is beneficial to Katherine, but does not impact premiums or payouts. In other embodiments, Katherine may adjust her initial elections so that she can withdraw some of the amount saved over the $6,000 or request a benefit over the $6,000 “rainy day savings goal.”

For example, as Katherine accumulates funds in her savings vehicle of between $1,000 and $6,000 (her goal), she may see a split premium. In other words, she may have a lower rate for the portion of the loan for which she has collateralized equity and a higher rate for the portion that remains uncollateralized. Upon the occurrence of a covered event during this time, the program would pay Katherine $6,000 for disability, hospitalization, and involuntary unemployment and $12,000 for death, according to the terms of the policy.

If Katherine has accumulated $6,001 or more in her savings vehicle (i.e., exceeding the pre-determined threshold of $6,000), her loan would be considered fully collateralized, and in some embodiments she would pay a lower premium than previously (i.e., before full collateralization) imposed. Again, upon the occurrence of a covered event during this time, the program would pay Katherine $6,000 for disability, hospitalization, and involuntary unemployment and $12,000 for death, according to the terms of the policy. These scenarios are illustrated in Table C, below.

TABLE C

| Savings | | |
|---|---|---|
| Status | Premium Impact | Fund Distribution |
| $1-$6,000 | Split Premium - Lower rate for | $6,000 for Disability, Hospitalization, |
| | collateralized equity; Higher rate for | and Involuntary Unemployment; |
| | uncollateralized equity | $12,000 for Death |
| $6,001 and | Lowest Premium - Loan is fully | $6,000 for Disability, Hospitalization, |
| up | collateralized | and Involuntary Unemployment; |
| | | $12,000 for Death |

Once the benefit is activated, according to Katherine's elections, Katherine would receive equal monthly disbursements over a period of six months. After a predetermined grace period (e.g., one month), she would begin to repay the loan amount over a period of 36 months at a no to low interest rate. Interest rates may vary according to whether the loan was or was not fully collateralized at the time the benefit is activated.

In various embodiments, if Katherine becomes delinquent for one payment, interest is then accrued on that payment and is added to the total due from her. The system may also track this repayment event and use it to determine whether the she will be eligible for the product in the future. Furthermore, if Katherine stops making payments before the loan is fully repaid, then the deficit may be taken from Katherine's savings vehicle, the collateral accumulated in the savings vehicle.

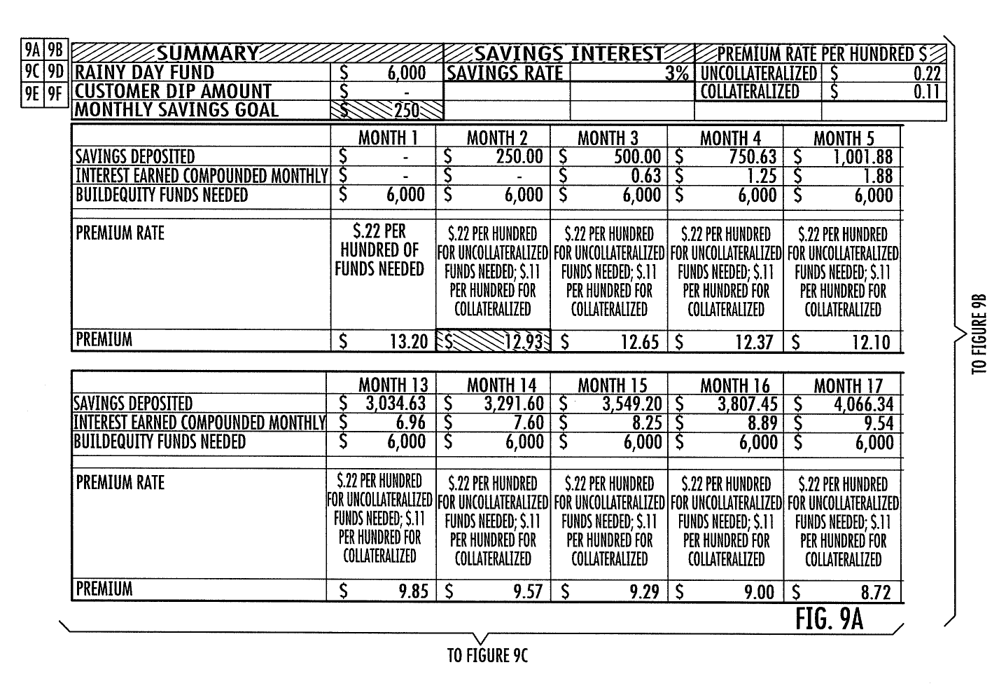

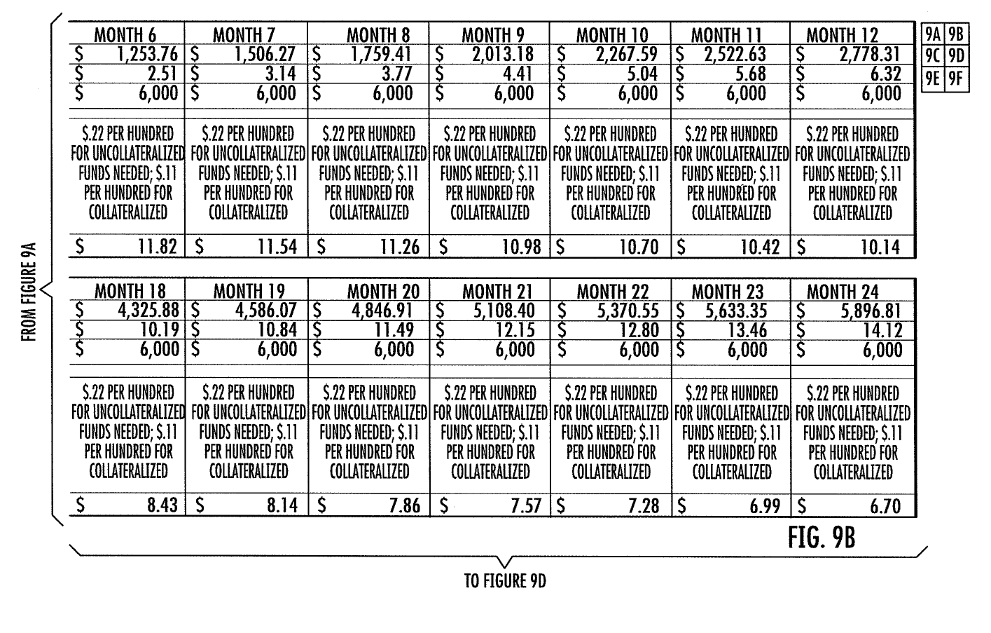

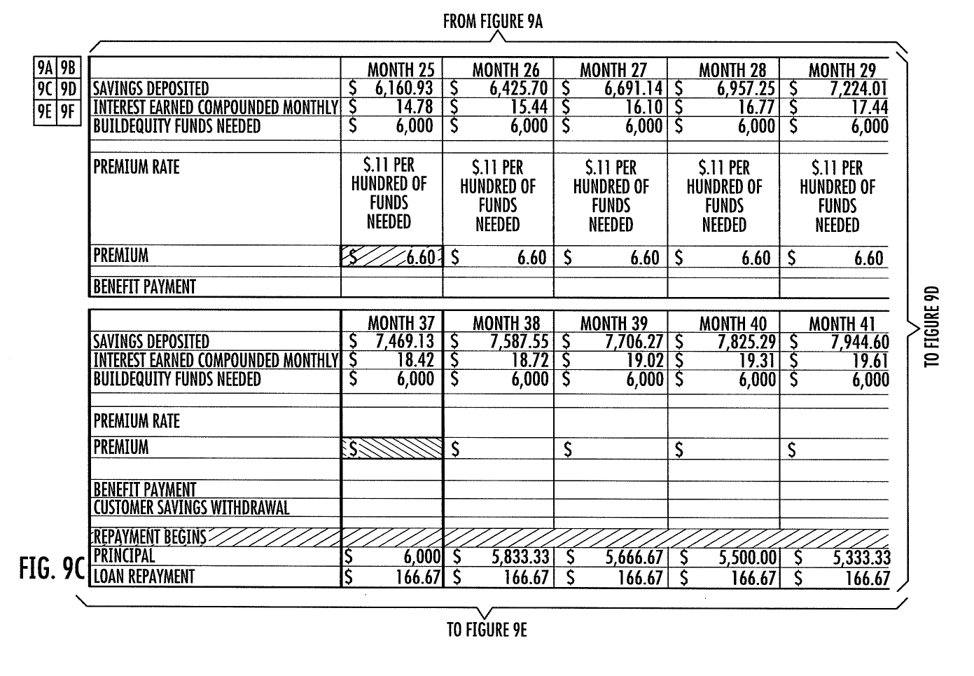

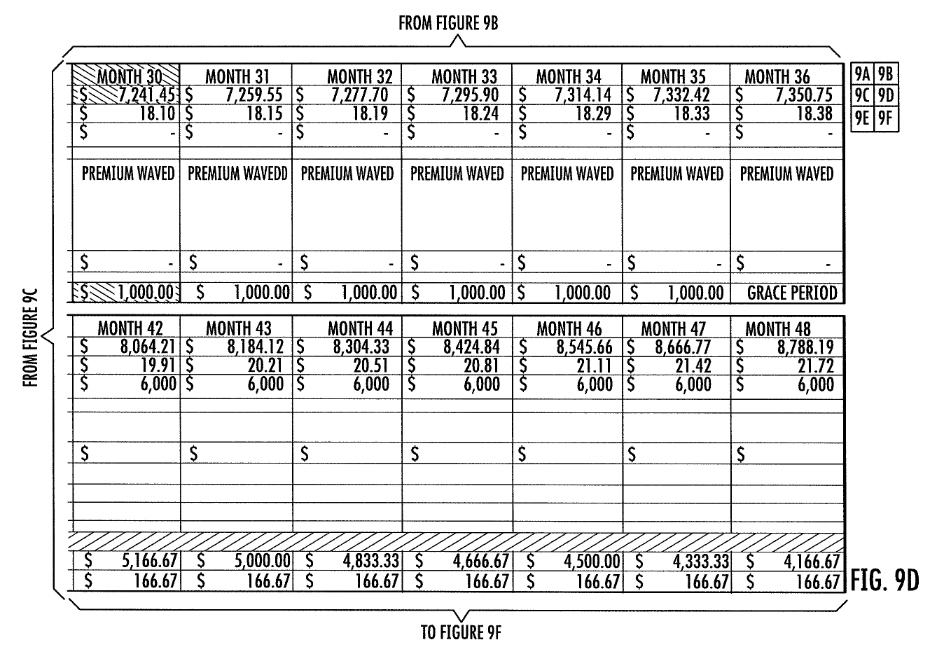

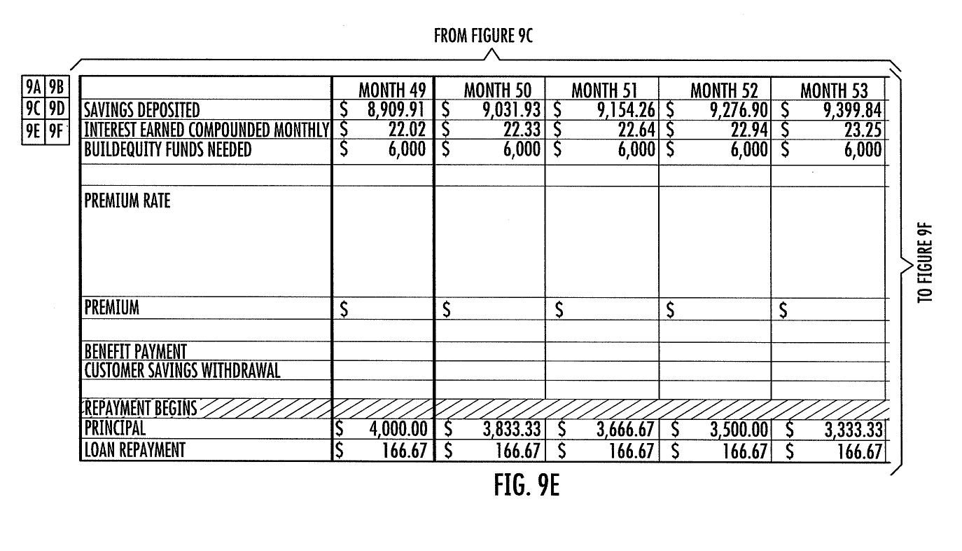

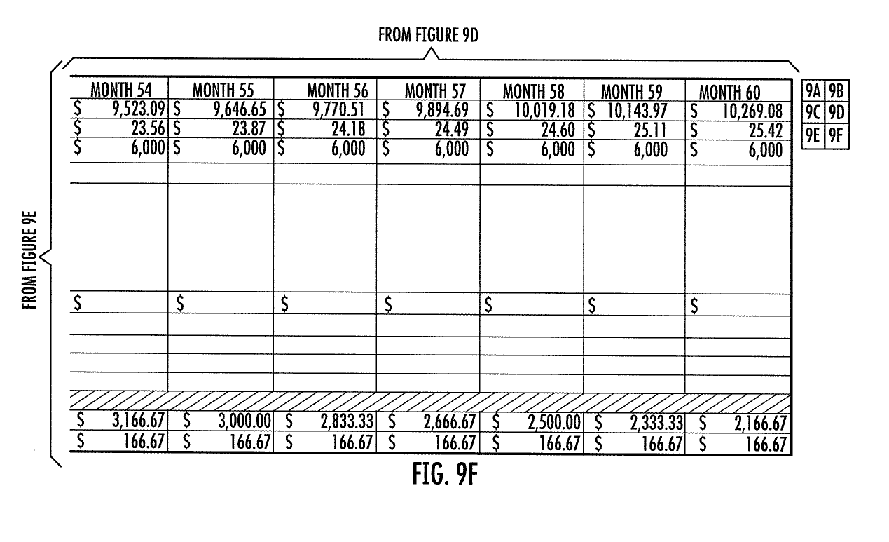

An example of Katherine's premium payments, savings accumulation, fund distribution, and repayment for a particular covered event is illustrated over 60 months in FIGS. 9a, 9B, and 9C. It is noted that the premium rates in the figures of $0.22 per hundred of uncollateralized funds needed and $0.11 per hundred for collateralized funds needed are exemplary in nature and are not meant to depict actual rates.

### Example 2

### “Jonathan Rhoads”

TABLE D
Customer Profile for “Jonathan Rhoads”

| | |
|---|---|
| Rainy Day Savings Goal | $6,000 |
| Risk Tolerance | Willing to dip into his savings up to $4,000; wants coverage |
| | for the remaining $2,000 |
| Program Options | Disability, Hospitalization, and Involuntary Unemployment |
| | coverage in the amount of 2× savings goal (i.e., $12,000) |
| Disbursement Options | Equal Installments Over 6 Months |
| Repayment Terms | 36 Months |
| Monthly Savings Goal | $250 |

As shown in Table D above, Jonathan has determined that he needs about $6,000 to cover his financial obligations in the event that he becomes unemployed, disabled or hospitalized. Unlike the previous example, however, Jonathan feels comfortable with dipping into his savings account up to $4,000 should that happen. He is looking for a financial product to cover him for the remaining $2,000. To work towards his goal, Jonathan plans on saving $250 per month.

Jonathan is approved and starts saving towards his goal and paying the monthly premium for the financial product. His first step is to build the $4,000 savings that he has identified he is willing to dip into should an event occur. Then he continues saving to collateralize the $2,000 for which the financial product is insuring him. As he progresses towards his savings goal, the computer system (e.g., the Benefit Collateralization Module) automatically adjusts the payout amount and premium rates. In some embodiments, any amount saved beyond $6,000 is beneficial to Jonathan, but does not impact premiums or payouts. In other embodiments, Jonathan may adjust his initial elections so that he can withdraw some of the amount saved over the $6,000 or request a benefit over the $6,000 “rainy day savings goal.”

As Jonathan accumulates funds in his savings vehicle of between $1,000 and $4,000 (his “dip amount” goal), he may see the highest rate charged for the monthly premium. Upon the occurrence of a covered event during these times, the program would pay Jonathan $6,000 (minus anything Jonathan has saved that goes towards his “dip” amount of $4,000) for disability, hospitalization, and involuntary unemployment and $12,000 for death, according to the terms of the policy. Thus, because his loan is not yet collateralized and the payout that would be required by the insurance company or lender would be higher than the planned $2,000 to make up for the deficit in his “dip” amount, Jonathan is seeing his highest monthly premiums being charged.

As Jonathan's funds increase from $4,001 to $6,000, he may see a split premium. In other words, he may have a lower rate for the portion of the loan for which he has collateralized equity and a higher rate for the portion that remains uncollateralized. Upon the occurrence of a covered event during these times, the program would pay Jonathan $2,000 for disability, hospitalization, and involuntary unemployment and $12,000 for death, according to the terms of the policy.

If Jonathan has accumulated $6,001 or more in his savings vehicle, exceeding the pre-determined threshold amount, his loan would be considered fully collateralized and in some embodiments he would pay a lower premium than previously imposed. Again, upon the occurrence of a covered event during this time, the program would pay Jonathan $2,000 for disability, hospitalization, and involuntary unemployment and $12,000 for death, according to the terms of the policy. These scenarios are illustrated in Table E, below.

TABLE E

| Savings | | |
|---|---|---|
| Status | Premium Impact | Fund Distribution |
| $1-$4,000 | Highest Premium - Loan is not | Up to $6,000 for Disability, |
| | collateralized; payout is higher because | Hospitalization, and Involuntary |
| | he has not reached his “dip” amount of | Unemployment; $12,000 for Death |
| | $4,000 | |
| $4,001- | Split Premium - Lower rate for | $6,000 for Disability, Hospitalization, |
| $6,000 | collateralized equity; Higher rate for | and Involuntary Unemployment; |
| | uncollateralized equity | $12,000 for Death |
| $6,001 and | Lowest Premium - Loan is fully | $6,000 for Disability, Hospitalization, |
| up | collateralized | and Involuntary Unemployment; |
| | | $12,000 for Death |

In various embodiments, once the benefit is activated, Jonathan receives equal monthly disbursements. He also draws from the money he has saved towards his $4,000 “dip” amount. After a one-month grace period, he begins to repay the loan amount over a period of 36 months at a no to low interest rate. Interest rates may vary according to whether the loan was or was not fully collateralized at the time of benefit.

In various embodiments, if Jonathan becomes delinquent for one payment, interest is then accrued on that payment and is added to the total due from him. The system may also track this repayment event and use it to determine whether the customer will be eligible for the product in the future. Furthermore, if Jonathan stops making payments before the loan is fully repaid, then the deficit may be taken from Jonathan's savings vehicle, i.e., the collateral accumulated in the savings vehicle.

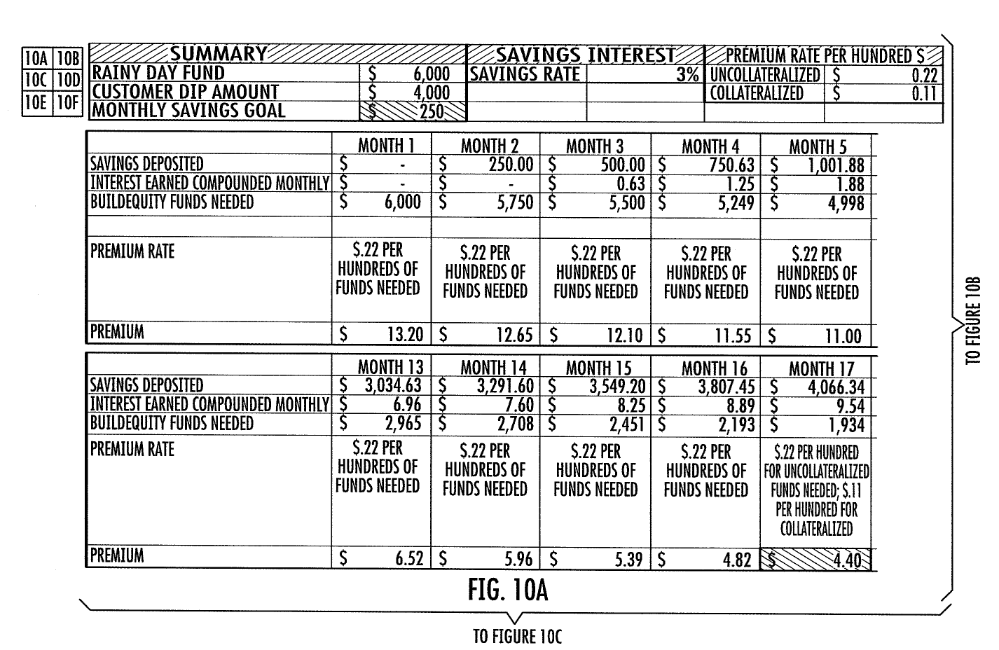

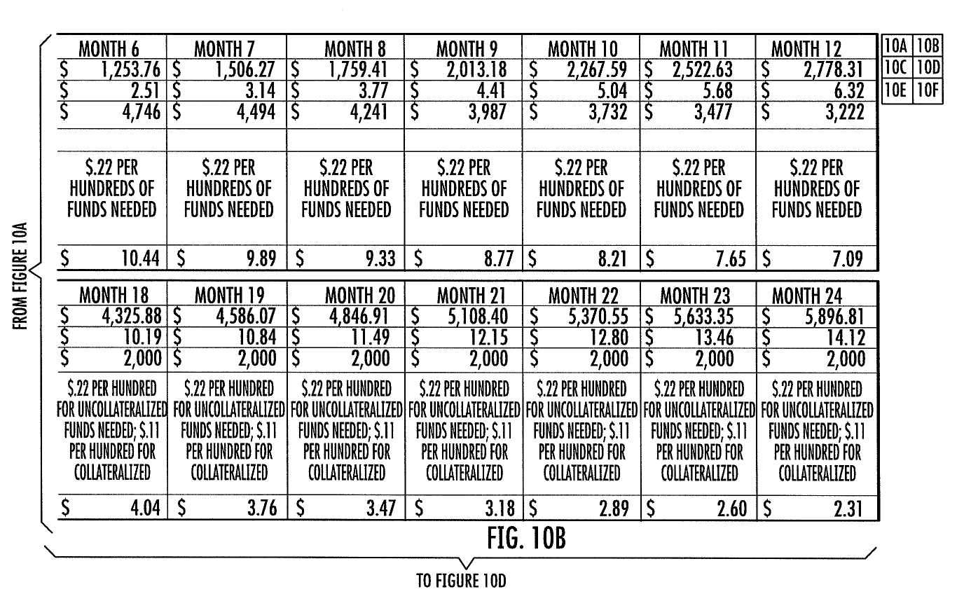

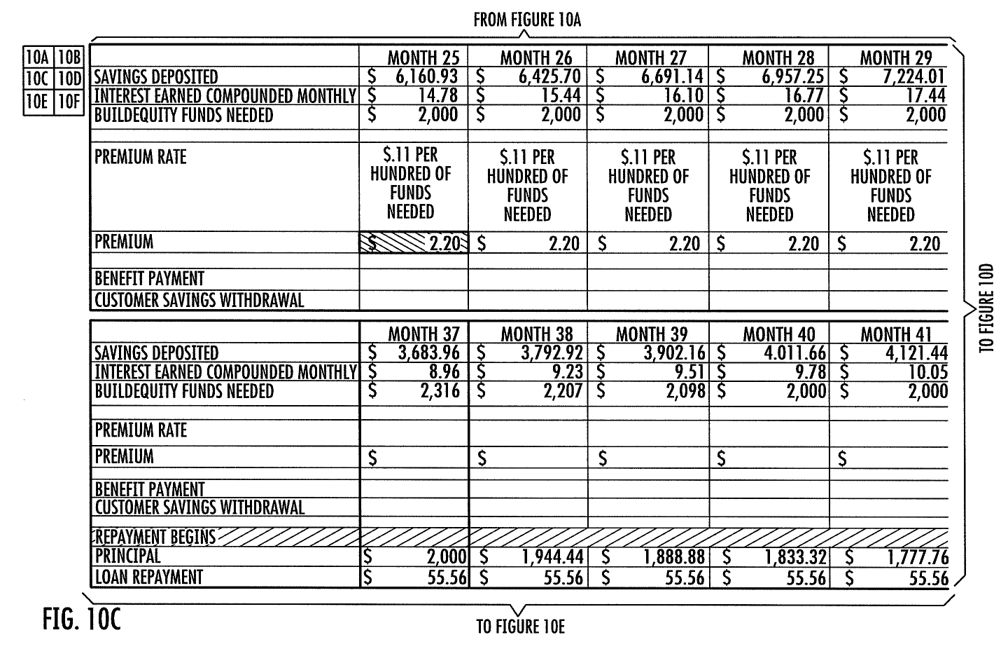

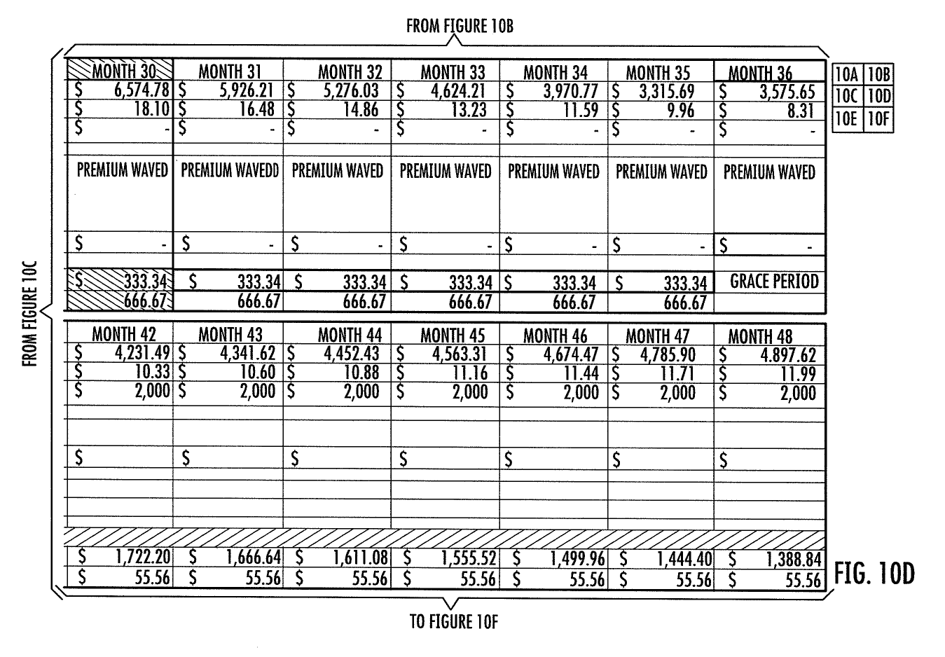

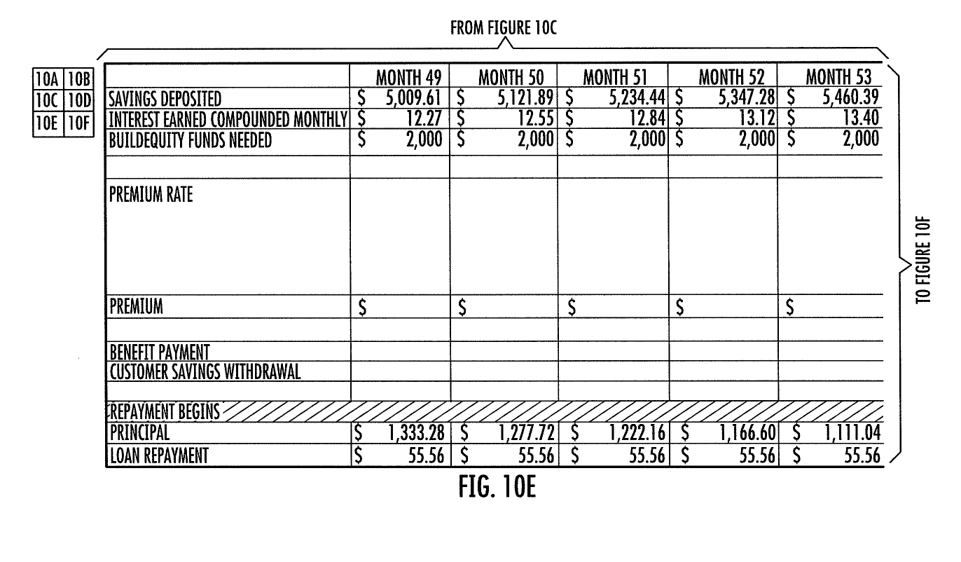

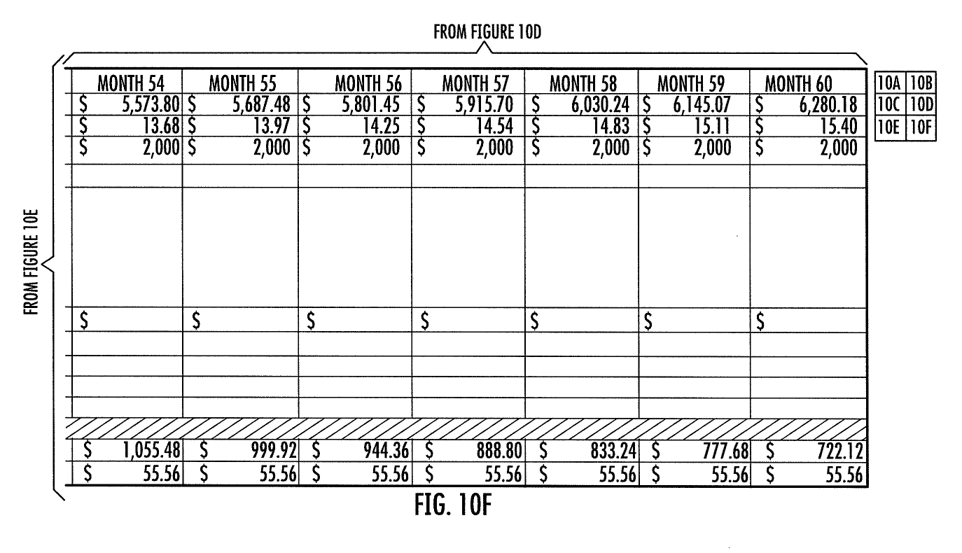

An example of Jonathan's premium payments, savings accumulation, fund distribution, and repayment for a particular covered event is illustrated over 60 months in FIGS. 10A, 10B, and 10C. It is noted that the premium rates in the figures of $0.22 per hundred of uncollateralized funds needed and $0.11 per hundred for collateralized funds needed are exemplary in nature and are not meant to depict actual rates.

### CONCLUSION

Thus, according to embodiments of the invention, customers can start on the path to building equity (e.g., by adding money to their selected savings vehicle) feeling secure in knowing that, should they undergo one of the pre-determined events, they will have access to a low/no interest loan (or other loan) that will help them get through that period of crisis.

For banks and other institutions that provide applicable savings vehicles, various embodiments of the financial product increase their deposits by encouraging customers to save more with the added assurance that if the customer undergoes one of the predetermined events, measures will be in place to help preserve their savings.

Thus, according to various embodiments of the invention, the financial product may offer customers a collateralized loan during a time of need, the ability to set and redefine savings goals to reflect changes in a customer's life, savings on fees as collateral grows, the waiver of monthly fees during benefit period and for a one-month grace period, and a manageable payback schedule once the benefit period begins.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A method of providing funds to a customer upon the occurrence of one or more pre-determined events, the method comprising the steps of
generating a user interface configured to receive loan application input from a customer including a designation of an associated savings vehicle;
upon approval of the loan application, calculating a periodic payment to be received from the customer; and
providing a guaranteed loan to said customer upon the occurrence of the one or more pre-determined events.

2. The method of claim 1, wherein the periodic payment is calculated based at least in part on a savings vehicle account balance.

3. The method of claim 1, wherein the loan application input includes a selection of at least one parameter by the customer.

4. The method of claim 3, wherein the periodic payment is determined based at least in part on the selection of the at least one parameter.

5. The method of claim 3, wherein the at least one parameter is selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit.

6. The method of claim 3, wherein the user interface is configured to receive input from the customer changing the selection of the at least one parameter.

7. The method of claim 6 further comprising adjusting the periodic payment based on the input received changing the selection of the at least one parameter.

8. The method of claim 1 further comprising calculating an estimated range of periodic payments and providing an indication of the estimated range of periodic payments to the customer through the user interface.

9. The method of claim 1 further comprising providing the customer with access to real-time account information through the user interface.

10. The method of claim 1 further comprising receiving the periodic payments made by the customer and tracking a savings vehicle account balance.

11. The method of claim 10 further comprising adjusting the periodic payments when the savings vehicle account balance exceeds a predetermined threshold amount.

12. The method of claim 1 further comprising withdrawing funds from the savings vehicle upon the customer's default on repayment of the guaranteed loan.

13. A computer readable storage medium comprising computer-executable instructions for:
generating a user interface configured to receive loan application input from a customer including a designation of an associated savings vehicle;
receiving information regarding a savings vehicle account balance; and
calculating a periodic payment to be received from the customer based at least in part on the savings vehicle account balance,
wherein a guaranteed loan is provided to said customer upon the occurrence of the one or more pre-determined events and the guaranteed loan is secured by the savings vehicle.

14. The computer readable storage medium of claim 13, wherein the loan application input includes a selection of at least one parameter by the customer.

15. The computer readable storage medium of claim 14, wherein the periodic payment is calculated based at least in part on the selection of the at least one parameter.

16. The computer readable storage medium of claim 14, wherein the at least one parameter is selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit.

17. The computer readable storage medium of claim 14, wherein the user interface is configured to receive input from the customer changing the selection of the at least one parameter.

18. The computer readable storage medium of claim 17 further comprising computer-executable instructions for adjusting the periodic payment based on the input received changing the selection of the at least one parameter.

19. The computer readable storage medium of claim 13 further comprising computer-executable instructions for calculating an estimated range of periodic payments and providing an indication of the estimated range of periodic payments to the customer through the user interface.

20. The computer readable storage medium of claim 13 further comprising computer-executable instructions for providing the customer with access to real-time account information through the user interface.

21. The computer readable storage medium of claim 13 further comprising computer-executable instructions for adjusting the periodic payments when the savings vehicle account balance exceeds a predetermined threshold amount.

22. A system for providing funds to a customer upon the occurrence of one or more pre-determined events, the system comprising:
a first user computer connected to a network and configured to receive loan application input from a customer;
a Product Implementation Server connected to the network, wherein the Product Implementation Server is configured to receive information from, process, and transmit information to the first user computer via the network,
wherein the Product Implementation Server is configured to receive at least some of the loan application input from the first user computer, to receive information regarding a savings vehicle associated with the customer, and to calculate a periodic payment to be received from the customer based at least in part on the loan application information and a savings vehicle account balance,
wherein a guaranteed loan is provided to said customer upon the occurrence of the one or more pre-determined events and the guaranteed loan is secured by the savings vehicle.

23. The system of claim 22, wherein the loan application input received by the Product Implementation Server includes a selection of at least one parameter by the customer.

24. The system of claim 23, wherein the periodic payment is calculated based at least in part on the selection of the at least one parameter.

25. The system of claim 23, wherein the at least one parameter is selected from the group consisting of a savings goal amount, a collateralized amount, a covered event, a monthly savings contribution amount, an interest rate of the guaranteed loan, a deferral period for loan repayment, a repayment period, an amount of the guaranteed loan, and a term limit.

26. The system of claim 23, wherein the first user computer is configured to receive input from the customer changing the selection of the at least one parameter.

27. The system of claim 26, wherein the Product Implementation Server is further configured to adjust the periodic payment based on the input received changing the selection of the at least one parameter.

28. The system of claim 22, wherein the Product Implementation Server includes a plurality of program modules selected from the group consisting of a Customer Election Module, a Benefit Distribution Election Module, a Benefit Collateralization Module, a Benefit Distribution Tracking Module, and a Benefit Recollection Tracking Module.

29. The system of claim 22 further comprising a second user computer connected to the network and associated with a provider of the guaranteed loan, wherein the second user computer is configured to provide the product provider with access to the information received, processed, and transmitted by the Product Implementation Server.

30. The system of claim 22, wherein the Product Implementation Server is configured to transmit information to the first user computer via the network to provide the customer with access to real-time account information.

31. The system of claim 22, wherein the Product Implementation Server is configured to adjust the periodic payments when the savings vehicle account balance exceeds a predetermined threshold amount.
